(19) United States
(12) Patent Application Publication
(10) Pub. No.: US 2005/0150399 A1
(43) Pub. Date: Jul. 14, 2005

(54) Automatic marking device for beverage dispenser

(76) Inventor: Timothy S. Wiley, Rowlett, TX (US)

Correspondence Address: Michael L. Diaz;Michael L. Diaz, P.C., Suite 200, 555 Republic Drive, Plano, TX, 75074, US

(21) Appl. No.: 10/756,076

(22) Filed: Jan. 12, 2004

(51) Int. Cl. B41K 1/38

(52) U.S. Cl. 101/35; 101/327

(57) ABSTRACT

An automatic marking device for a conventional drink dispenser. The device is used for automatically marking beverage containers receiving beverages from a conventional drink dispenser. The drink dispenser include a plurality of stations, each station dispensing a different type of beverage. In one embodiment, the drink dispenser includes a plurality of triggers, each trigger being associated with each station. A marking device, such as a self-inking stamper, is affixed to the trigger. The container is pressed against the trigger of the desired station to dispense the beverage from the desired station and mark the container to indicate the type of beverage dispensed. In another alternate embodiment, the trigger arm is replaced with an actuating button. In addition, an extendable stamper is affixed to a back splash of the drinking dispenser. When the actuating button is depressed, the desired beverage is dispensed and the stamper extends to mark the container.

### BACKGROUND OF THE INVENTION

1. Technical Field of the Invention

This invention relates to marking devices, and more particularly, to an automatic marking device for marking beverage containers utilizing conventional beverage dispensers.

2. Description of Related Art

Beverage dispensers are commonly used in the food and restaurant industries. The beverage dispensers provide a convenient way for both a customer serving himself as well as employees serving others within restaurants. The beverage dispensers allow an operator to position a beverage container underneath a conventional beverage dispenser and activate the dispenser to fill the container with a beverage. However, difficulties often arise in determining the contents of a filled container. It can be particularly difficult to determine the type of beverage which have the same color, such as a cola and a diet cola. In existing beverage containers, it is common to place a lid on top of the container. The lid oftentimes includes several labeled “bubbles” which may be depressed to indicate the type of beverage filled within the container. For example, if the beverage is a diet cola, the appropriate bubble indicating that the beverage is diet is depressed. This depression would indicate to the consumer which drink is a diet drink. However, this existing system suffers from several disadvantages. First the dispenser operator must remember to depress the proper bubble. With the servicing of a multitude of drinks, it is common for the operator to forget or accidently depress the wrong bubble. In addition, many times the bubbles provide a limited number of selections. For example, the bubbles may include a lid to differentiate diet cola from a cola. However, there may not be a selection for a plurality of dark-colored beverages (e.g., different brands of cola or root beer). An apparatus is needed which provides for automatically marking a beverage container used with a conventional beverage dispenser, without requiring any additional effort or thought by the operator.

Although there are no known prior art teachings of a device such as that disclosed herein, prior art references that discuss subject matter that bears some relation to matters discussed herein are U.S. Pat. No. 4,319,441 to Credle et al. (Credle), U.S. Pat. No. 5,000,345 to Brogna et al. (Brogna), and U.S. Pat. No. 6,102,246 to Goulet et al. (Goulet).

Credle discloses a self-contained drink dispenser for use with a post-mix system. The system includes a cup dispenser, a soft drink dispenser, an ice dispenser for depositing ice into the cups, an automatic lid dispenser for capping the cups, and a marker for marking the lids with indicia identifying the contents of the cup. However, Credle does not teach or suggest a marking device for use with a manual drink dispenser. Credle merely discloses a complicated apparatus which completely packages and marks the beverage and the lid of the container. Credle also only marks the lid, rather than the outer surface of the container

Brogna discloses an automated drink maker system which is designed to accept an input drink order, such as from a cash register, and deliver the drink order, for different sizes and different flavor, completely finished in lid containers to an output station. At the output station, the cup is transferred from the carousel to a linear transporter elevator which carries the cup up and down through a lidding and marking procedure. However, Brogna does not teach or disclose automatically marking the containers when dispensing drinks from a manually operated drink dispenser. Brogna, in a similar fashion to Credle, discloses a complex automated drink dispenser which doesn't even mark the container, but merely the lid.

Goulet discloses another automated system for preparing and delivering post-mix beverages in response to one or more drink orders being entered from a remote point of a sale unit. The system includes a post-mix beverage preparation assembly for dispensing ice and a selected post-mix beverage into a cup. The system also includes an oblong carousel type conveyor assembly having a plurality of upwardly open cup holders which are driven by a motor so as to pass beneath a cup dispensing station, an ice dispensing station, a beverage dispensing station, and a plurality of pick-up stations. However, Goulet does not teach or suggest a marking device for marking containers by a drink dispenser.

Review of the foregoing references reveals no disclosure or suggestion of an apparatus for automatically marking a beverage container receiving a beverage from a beverage dispenser. It is an object of the present invention to provide such an apparatus.

### SUMMARY OF THE INVENTION

In one aspect, the present invention is a marking apparatus attached to a conventional drink dispenser. The apparatus includes a marking mechanism affixed to the conventional drink dispenser. The marking mechanism is associated with a specific type of beverage. The marking mechanism is actuated to mark a container positioned under the drink dispenser for the specific type of beverage. The marking mechanism marks the container with a marking indicating the specific type of beverage dispensed into the container.

In another aspect, the present invention is a drink dispensing system. The system includes a drink dispenser having a plurality of stations. Each station dispenses a specific type of beverage. The system also includes a marking mechanism located at each station. Each marking mechanism provides a mark for determining the specific type of beverage of the station. The drink dispenser is actuated to dispense a specific type of beverage associated with each station. A beverage container is positioned under one of the plurality of stations and the drink dispenser is actuated to simultaneously mark the container and dispense the specific type of beverage from the station where the container is located.

In still another aspect, the present invention is a drink dispensing system. The system includes a drink dispenser having a plurality of stations. Each station dispenses a specific type of beverage. A trigger is located at each station. In addition, a marking device is located at each station. The marking device creates a specific mark to determine the type of beverage dispensed. When a beverage container is positioned under one of the plurality of stations and pressed against the trigger of the selected station, the selected type of beverage is dispensed and a marking is affixed to the container to indicate the type of beverage dispensed.

### BRIEF DESCRIPTION OF THE DRAWINGS

The invention will be better understood and its numerous objects and advantages will become more apparent to those skilled in the art by reference to the following drawings, in conjunction with the accompanying specification, in which:

FIG. 1 is a front view of a drink dispenser according to the teachings of the present invention;

FIG. 2 is a partial enlarged side view of the trigger mechanism of FIG. 1 having the marking mechanism in the preferred embodiment of the present invention;

FIG. 3 is a front view of the beverage container;

FIG. 4 is a front view of a dispenser in an alternate embodiment of the present invention; and

FIG. 5 is an enlarged side view of the marking mechanism of FIG. 4.

### DETAILED DESCRIPTION OF EMBODIMENTS

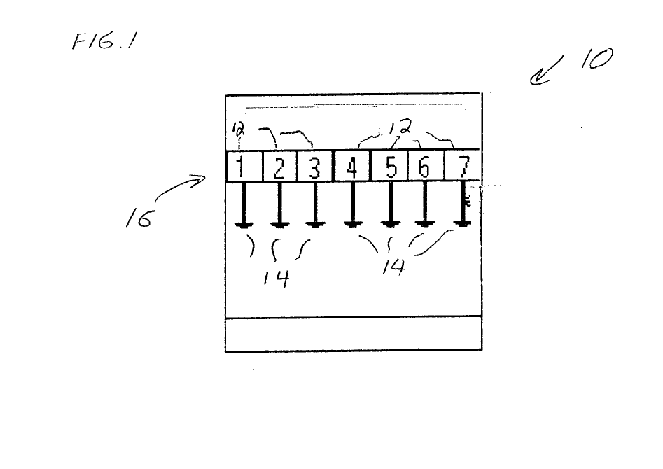

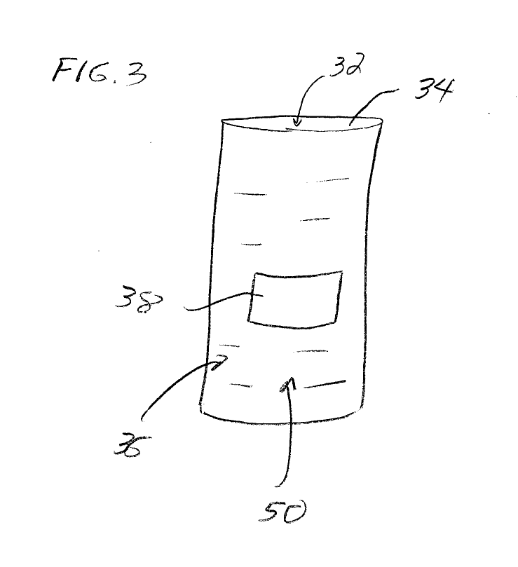

A device for automatically marking beverage containers receiving beverages at a beverage dispenser is disclosed. FIG. 1 is a front view of a drink dispenser 10 according to the teachings of the present invention. The drink dispenser includes a plurality of stations 12. Each station includes a trigger mechanism 14. Actuation of the trigger mechanism discharges a specific beverage from a top section 16 downward. In the preferred embodiment of the present invention, a beverage container 30 (FIG. 3) is positioned under a desired station 12. The container is moved backwards to provide force to the trigger, thereby actuating the dispenser and allowing a beverage to fall from the top section into an opening 32 of the container. The drink dispenser 10 is a conventional drink dispenser and is well known in the food and restaurant industries.

The beverage dispenser 10 provides a unique marking mechanism 18. The marking mechanism is preferably positioned on an outer surface of the trigger mechanism 14. In the preferred embodiment of the present invention, the marking mechanism is a “self-inking” stamper affixed to the trigger mechanism. The self-inking stamper typically includes a stationary swivelable stamper that inks itself automatically by rotating its stamping pad during use. A self-inking stamper is well known to those skilled in the manufacture of marking devices. When force is applied to the trigger mechanism, the marking mechanism marks the beverage container 30. When the trigger mechanism is released, the marking mechanism (in the self-inking stamper embodiment) may rotate to supply ink to the stamper. However, in alternate embodiments of the present invention, the marking mechanism may automatically ink itself as the trigger is actuated. In still other embodiments of the present invention, the marking mechanism may be any marking device which provides sufficient markings for a consumer or operator to distinguish the markings.

The marking mechanism 18 may mark the beverage container 30 with a wide variety of markings. In one embodiment, the name or logo of the dispensed beverage may be marked upon the beverage container. In another embodiment of the present invention, a coloring, coding, or numbering system may be employed to differentiate the type of beverage dispensed into the beverage container. In the preferred embodiment of the present invention, each station 12 has a different mark used for marking the beverage container.

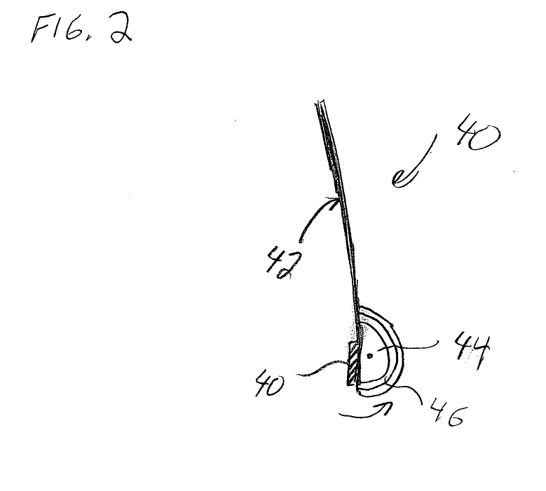

FIG. 2 is a partial enlarged side view of the trigger mechanism 14 of FIG. 1 having the marking mechanism 18 in the preferred embodiment of the present invention. In the preferred embodiment of the present invention, the marking mechanism includes a stamper 40 located on an outer surface 42 of the trigger mechanism. The stamper is rotatably affixed to the bottom of the trigger mechanism. The stamper may rotate about a pivot point 44. At a specified point in time, prior to actuation of the marking device, the stamper rotates into an internally mounted stamping pad 46. Ink is applied to the stamper, after which the stamper rotates out to its original position. The beverage container is then pressed against the inked stamper, thus applying a mark to the beverage container. As stated above, other marking devices may be used to apply a mark from the trigger mechanism to the beverage container.

FIG. 3 is a front view of the beverage container 30. The beverage container includes the opening 32 located on a top container end 34. The container includes a cylindrical outer surface 36. On a portion of the outer surface, there may optionally be positioned a blank marking area 38. The marking area may be constructed of a different material than the outer surface of the container, more conducive for application of a mark. The marking area may be an adhesive label applied to the container. However, in other embodiments of the present invention, the marking area is not used.

With reference to FIGS. 1-3, the operation of the marking mechanism 18 will now be explained. The beverage container is positioned under one of the stations 12, depending on the beverage for which the operator or consumer desires. The beverage container is pressed against the trigger mechanism 14. As force is applied backwards to the trigger mechanism, the stamper 40 is rotated into the stamping pad 46, thereby automatically supplying ink to the stamper. After supplying ink to the stamper, the stamper rotates back to its original position, allowing the stamper to contact the outer surface 36 of the beverage container. The container may optionally include the blank marking area 38 which, if used, is positioned against the stamper while applying force to the trigger mechanism.

The stamper 40 marks the container with a distinctive mark to distinguish the type of beverage dispensed by the dispenser 10. Simultaneously, the dispenser 10 discharges the desired beverage from the top section 16 of the dispenser through the opening 32 into an interior area 50 of the container. The operator or consumer may then differentiate several drinks from each other by referencing the applied marking located on the outer surface 36 of the beverage container 30.

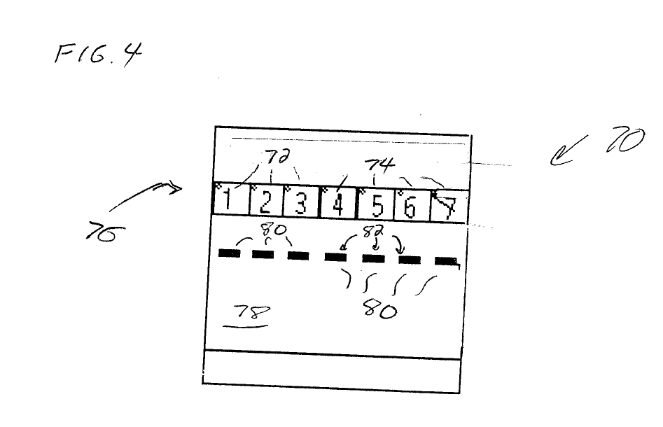

FIG. 4 is a front view of a dispenser 70 in an alternate embodiment of the present invention. Many times, drink dispensers do not include a trigger mechanism 14 discussed above. Instead, a button is used to actuate the dispenser for discharge of a selected beverage into a container. The dispenser 70 includes a plurality of stations 72. Each station 72 is associated with a specific type of beverage. The dispenser 70 includes an actuating button 74 located on a top portion 76 of the dispenser 70. Depression of the actuating button 74 activates the dispenser 70 to dispense a selected beverage through a top portion 76 of the dispenser into the beverage container (when positioned at the selected station 72). At a back splash 78 of the dispenser 70 is a plurality of marking mechanisms 80. Each marking mechanism is associated with its particular beverage and station. The marking mechanism applies a mark to distinguished the type of beverage dispensed from the station.

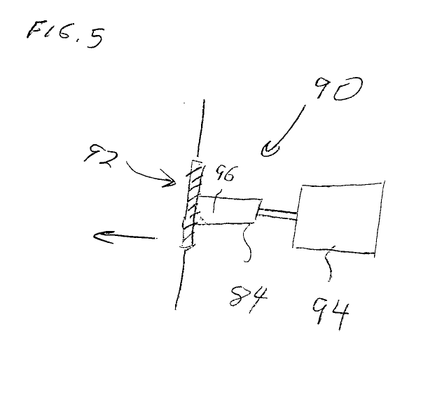

FIG. 5 is an enlarged side view of the marking mechanism 80 of FIG. 4. The marking mechanism may be a self-inking stamping mechanism similar to the stamper 40, having a stamper 90 and an ink pad 92. The stamping mechanism 82 may also include an extendable arm 84, attached to a drive piston 94 positioned internally within the drink dispenser 70. The stamping mechanism may also include an ink reservoir 96 containing a supply of ink for marking.

When the actuating button 74 is depressed, the stamper 90 may receive a steady supply of ink from the ink reservoir 96. In addition, the extendable arm 84 is driven outwardly beyond an outer back splash surface 98 approximately 3 inches. The actual distance that the arm drives the ink pad 92 is dependent upon the distance that a beverage container is located from the back splash surface. The ink pad must be driven to a position that it contacts the beverage container outer surface 36. Although a drive piston is illustrated, a device which allows a mark to be applied on a positioned beverage container may be utilized.

With reference to FIGS. 3-5, the operation of the drink dispenser 70 will now be explained. The beverage container 30 is positioned under a desired station 72, depending upon which beverage is desired by the operator or consumer. Each station 72 is associated with a specific beverage. The consumer chooses the appropriate beverage and positions the container at the station associated with the desired beverage. The container is located approximately 2-3 inches from the back splash 78. The actuating button 74 located above the beverage container is depressed. The desired beverage is dispensed from the top portion 76 of the dispenser. Simultaneously, the stamper 90 is actuated.

In the preferred embodiment of the present invention, the ink pad 92 is supplied ink from the ink reservoir 96. In addition, the ink pad 92 is driven outwardly by the drive piston 94. The ink pad is extended a distance necessary to contact the outer surface 36 of the container. A mark is affixed to the outer surface indicating the type of beverage dispensed within the container. If the outer surface includes the blank marking area 38, the container may be positioned to allow the ink pad to contact within the marking area. When the actuating button 74 is released, the ink pad is retracted to its stored position, flush with the back splash 78. As discussed with the marking mechanism 18, any marking device may be used. The ink pad is only one system which may be employed to automatically mark the beverage container 30. In addition, any marking coding scheme may be used to differentiate the type of beverage dispensed into each container.

The marking mechanisms described above provide many advantages over existing drink dispensers. The marking mechanisms provide an effective and simple method of marking beverage containers to assist in differentiating the type of beverage dispensed. The dispenser operator does not need to perform any additional steps to mark the container. In addition, by automating the marking process, improper marking of the containers is completely avoided.

It is thus believed that the operation and construction of the present invention will be apparent from the foregoing description. While the apparatus shown and described has been characterized as being preferred, it will be readily apparent that various changes and modifications could be made therein without departing from the scope of the invention as defined in the following claims.

1. A marking apparatus attached to a conventional drink dispenser, the apparatus comprising:
a marking mechanism affixed to the conventional drink dispenser, said marking mechanism associated with a specific type of beverage; and
means for actuating said marking mechanism to mark a container positioned under the drink dispenser for the specific type of beverage;
whereby said marking mechanism marks the container with a marking indicating the specific type of beverage dispensed into the container.

2. The marking apparatus of claim 1 wherein:
the conventional drink dispenser includes a trigger for actuating the drink dispenser and marking mechanism; and
said marking mechanism is an ink stamper affixed to the trigger;
whereby the container is pressed against the trigger to simultaneously mark the container and dispense the specific type of beverage into the container.

3. The marking apparatus of claim 2 wherein the ink stamper includes a means for supplying ink to the stamper.

4. The marking apparatus of claim 1 wherein:
the conventional drink dispenser includes a trigger for actuating the drink dispenser; and
said marking mechanism is affixed to the trigger;
whereby the container is pressed against the trigger to simultaneously mark the container and dispense the specific type of beverage into the container.

5. The marking apparatus of claim 1 wherein:
the conventional drink dispenser includes an actuating button to actuate the drink dispenser and dispense the specific type of beverage and a back splash;
said marking mechanism is affixed to the back splash;
whereby the container is simultaneously marked by said marking mechanism and the specific type of beverage is dispensed into the container when the actuating button is depressed.

6. The marking apparatus of claim 5 wherein said marking mechanism in the retracted position is flush with the back splash and extends outwardly to contact the container positioned in the drink dispenser when the actuating button is depressed.

7. The marking apparatus of claim 6 wherein said marking mechanism is an ink stamper.

8. A drink dispensing system, the system comprising:
a drink dispenser having a plurality of stations, each station dispensing a specific type of beverage;
a marking mechanism located at each station, said marking mechanism providing a mark for determining the specific type of beverage of the station; and
means for actuating the drink dispenser to dispense a specific type of beverage associated with each station;
whereby a beverage container is positioned under one of the plurality of stations and the drink dispenser is actuated to simultaneously mark the container and dispensed the specific type of beverage from the station where the container is located.

9. The drink dispensing system of claim 8 wherein said means for actuating the drink dispenser is a trigger protruding from the drink dispenser which dispenses a specific type of beverage when force is applied to the trigger.

10. The drink dispensing system of claim 9 wherein said marking mechanism is affixed to the trigger, said marking mechanism marking the container when the container is pressed against the trigger.

11. The drink dispensing system of claim 10 wherein the marking mechanism is a self-inking stamper.

12. The drink dispensing system of claim 8 wherein said means for actuating the drink dispenser includes an actuating button for each station, whereby depressing the actuating button dispenses a type of beverage from the station selected.

13. The drink dispensing system of claim 12 wherein:
a back splash is located on the drink dispenser; and
said marking mechanism includes a marking device located on the back splash at each station, whereby depressing the actuating button of a selected station actuates the marking device of the selected station, said marking device marking the container with a mark indicating the type of beverage dispensed from the selected station.

14. The drink dispensing system of claim 13 wherein each marking device is a self-inking stamper providing a mark associated with the type of beverage dispensed from the selected station.

15. The drinking dispensing system of claim 14 wherein each marking device includes an extendable arm, said arm extending outwardly toward the container allowing contact between the container and the stamper when the actuating button is depressed.

16. A drink dispensing system, the system comprising:
a drink dispenser having a plurality of stations, each station dispensing a specific type of beverage;
a trigger located at each station,
a marking device located at each station, said marking device having means for creating a specific mark to determine the type of beverage dispensed;
whereby a beverage container is positioned under one of the plurality of stations and pressed against the trigger of the selected station to dispense the type of beverage selected and marking the container to indicate the type of beverage dispensed.
